(19) United States
(12) Patent Application Publication
(10) Pub. No.: US 2025/0223458 A1
(43) Pub. Date: Jul. 10, 2025

(54) PIGMENT PASTE AND USE THEREOF

(71) Applicant: Ewald Dörken AG, Herdecke (DE)

(72) Inventors: Marcel Roth, Düsseldorf (DE); Daniel Miri, Wuppertal (DE); Irina Konn, Herdecke (DE); Peter Matthée, Herdecke (DE); Justine Schmitz, Herdecke (DE); Torsten Zimny, Langenfeld (DE)

(73) Assignee: Ewald Dörken AG, Herdecke (DE)

(21) Appl. No.: 18/705,299

(22) PCT Filed: Nov. 22, 2022
(86) PCT No.: PCT/EP2022/082813

§ 371 Date: Apr. 26, 2024

(30) Foreign Application Priority Data
Nov. 23, 2021 (EP) 21209836.2

(51) Int. Cl. C09D 17/00; C08K 3/30; C09D 7/45; C09D 7/61

(52) U.S. Cl. CPC C09D 17/001; C09D 7/45; C09D 7/61; C09D 17/007; C08K 2003/3045

(57) ABSTRACT

An aqueous composition configured as a pigment paste for tinting systems, the composition comprising an inorganic compound of a trivalent metal with a solubility of less than 5 g/l at 20° C. in water.

### CROSS REFERENCE TO RELATED APPLICATIONS

The present application is the U.S. national stage application of international application PCT/EP2022/082813, filed Nov. 22, 2022, which international application was published on Jun. 1, 2023, as international publication no. WO 2023/094379. The international application claims priority to European patent application no. 21209836.2, filed Nov. 23, 2021. The international application and the European application are hereby incorporate herein by reference in their entireties.

### FIELD

The present invention relates to the technical field of surface coating.

### BACKGROUND

Modern coating systems, in particular paint compositions, are increasingly being formulated on a water basis, as these should preferably be free of volatile organic compounds, i.e. VOC-free (volatile organic compound). Such VOC-free paint systems or systems with a VOC content of less than 1 g/l are considered to be solvent-free and emission-free. From the point of view of environmental and health protection, these systems are not problematic, or at least less problematic than solvent-based systems.

In addition, efforts are being made to avoid, or at least reduce, the use of preservatives and biocides in paints. If the paint systems do not contain any preservatives or biocides, there is generally no need to declare any hazardous substances and the paints can be applied and processed without any problems or special safety precautions.

### SUMMARY

In particular, the present invention relates to an aqueous composition, in particular a pigment paste, for incorporation into colors and paints.

Furthermore, the present invention relates to the use of a pigment paste in surface coating systems, in particular paints.

Furthermore, the present invention relates to a kit-of-parts for producing a coating composition.

### DETAILED DISCLOSURE

In practice, the use of aqueous systems, in particular in combination with organic binder systems, regularly leads to a rapid infestation of the paint with germs, in particular bacteria, yeasts or even mold, so that preservatives and/or biocides usually have to be added to the paint. This applies in particular to aqueous pigment pastes, such as those used for tinting systems. Tinting systems are generally used to provide a variety of different colors and shades that can be individually selected and combined by customers. Tinting systems usually consist of a range of colored pigment pastes, which are mixed with a binding agent or a binding agent mixture, the so-called tinting base or base composition, in order to obtain paints, in particular wall paints, with a desired hue. The pigment pastes are highly concentrated pigment-containing dispersions. The pigment paste and the base or tinting base together form the ready-to-use color or ready-to-use coating.

The mixing of individual pigment pastes in varying quantities with the tinting base is effected in machines in which the mixing process is carried out with software support. The pigment pastes are stored more or less openly for several weeks after being removed from the original container and are exposed to germs, in particular bacteria, yeasts and mold spores, via the ambient air during this time, which almost inevitably leads to infestation with bacteria, yeasts or mold in solvent-free or water-based systems.

For this reason, preservatives and biocides are used almost exclusively in water-based pigment pastes and tinting systems. However, the use of biocides and preservatives is disadvantageous for a number of reasons, as biocides and preservatives generally represent problematic substances for both health protection and environmental protection, the use of which should be minimized and the use of which is increasingly strictly regulated by stricter chemicals legislation. In addition, a serious disadvantage of conventional organic biocides is their vapor pressure: the biocides transition into the gas phase and can, for example, trigger allergies, wherein in particular there is also a risk of the biocides accumulating in the air indoors. Furthermore, organic biocides are usually not stable in the long term and are decomposed by UV radiation, for example.

There are therefore attempts to provide aqueous pigment pastes, in particular for tinting systems, without preservatives or biocides. For this purpose, the pH value of the pigment paste is usually set to a value of 10 or higher, creating an environment in which many bacteria and yeasts as well as the majority of fungi cannot grow.

However, as the use of these systems increases, it becomes apparent that there are a large number of alkaliphilic bacteria, yeasts and fungi, in particular molds, that either grow well under these alkaline conditions or can successfully adapt to these conditions. In order to combat these alkaliphilic germs, preservatives and biocides must be used.

Calcium aluminate sulphate, which comprises the mineral ettringite with the molecular formula Ca₆Al₂[(OH)₁₂(SO₄)₃]·26 H₂O, is also known to be used as a white pigment in paints and paper coatings. Calcium aluminate sulphate is marketed in the form of an aqueous basic suspension and can be added in small quantities to paints in particular. A method for producing precipitates based on calcium aluminate sulphate is described in WO 97/35807 A1. The use of large quantities of calcium aluminate sulphate in binder systems is not possible, as binder systems thicken rapidly due to the relatively good solubility in water and thus the quantities of divalent and trivalent ions present in the dispersion. In particular, coagulation of dispersed components, especially electrostatically stabilized components, is observed. However, the divalent and trivalent ions present in the solution, in particular aluminum ions, also mean that the aqueous suspensions of calcium aluminate sulfate comprise a germ-resistant effect that goes beyond the basic pH value, i.e. the aqueous suspensions of calcium aluminate sulfate are difficult to be attacked or colonized by germs of all kinds, in particular bacteria, yeasts or molds.

However, calcium aluminate sulphate has the further disadvantage of being less stable to dispersion and drying out quickly when processed in colors, i.e. the open time of the colors is very short.

The prior art therefore still lacks both an aqueous-based coating composition and an aqueous-based pigment paste which can be formulated without preservatives and biocides, has a long open time and is resistant to infestation by microorganisms, in particular bacteria or mold.

Consequently, one object of the present invention is to avoid, or at least mitigate, the disadvantages associated with the prior art described above.

In particular, one object of the present invention is to provide a pigment paste which is solvent-free or VOC-free and SVOC-free and which is at the same time free of biocides and preservatives, in particular volatile biocides and preservatives.

Furthermore, one object of the present invention is to provide a pigment paste which is also resistant to alkaliphilic bacteria, yeasts and molds.

A further object of the present invention is to provide a tinting system which enables simple tinting of a large number of aqueous binder systems. In particular, one object of the present invention is to provide an inorganic, pigment-based and germ-resistant additive which does not impair the color characteristics of coating compositions.

The subject-matter of the present invention according to a first aspect of the present invention is thus an aqueous composition according to claim 1; further, advantageous configurations of this aspect of the invention are the subject-matter of the dependent claims relating thereto.

Further subject-matter of the present invention according to a second aspect of the present invention is the use of an aqueous composition according to claim 12.

Again, a further subject-matter of the present invention according to a third aspect of the present invention is a kit-of-parts according to claim 13; further, advantageous configurations of this aspect of the invention are the subject-matter of the dependent claims relating thereto.

Again, a further subject-matter of the present invention according to a fourth aspect of the present invention is a composition according to claim 15; further, advantageous configurations of this aspect of the invention are the subject-matter of the dependent claims relating thereto.

Finally, according to a fifth aspect of the present invention, a further aspect of the present invention is a composition according to claim 19; further, advantageous configurations of this aspect of the invention are the subject-matter of the dependent claims relating thereto.

It goes without saying that special features, characteristics, configurations and embodiments as well as advantages or the like, which are explained below—for the purpose of avoiding unnecessary repetition—with respect to only one aspect of the invention, naturally apply according to the other aspects of the invention, without the need for express mention.

In addition, it should be noted that in the case of all the relative or percentage, in particular weight-related, quantities mentioned below, these are to be selected by the skilled person in the context of the present invention in such a way that the sum of the ingredients, additives or auxiliary substances or the like always results in 100% or 100% by weight. However, this is self-evident to the person skilled in the art.

In addition, all the parameter details or the like mentioned below can in principle be determined or ascertained using standardized or explicitly stated determination methods or using determination methods that are familiar to the person skilled in the art.

With this being said, the subject-matter of the present invention is explained in more detail below.

Subject-matter of the present invention—according to a first aspect of the present invention—is thus an aqueous composition, in particular pigment paste for tinting systems, wherein the composition comprises an inorganic compound of a trivalent metal with a solubility of less than 5 g/l at 20° C. in water.

In particular, the inorganic compound of a trivalent metal is selected from the group of yttrium, scandium, lanthanum, the lanthanides, vanadium, chromium, molybdenum, tungsten, iron, boron, aluminum and mixtures thereof. Preferably, the trivalent metal is selected from the group consisting of scandium, yttrium, lanthanum, cerium, boron, aluminum and mixtures thereof. Even more preferably, the trivalent metal is selected from the group consisting of lanthanum, cerium, boron, aluminum and mixtures thereof. Best results are obtained if the trivalent metal is aluminum.

In the context of the present invention, a trivalent metal is to be understood in particular as a metal which forms stable ions in the +III oxidation state under normal conditions, i.e. at 25° C. and a pressure of 1.013 bar.

This is because, as the applicant has surprisingly found out, stable pigment pastes can be produced which are suitable for incorporation into binder systems for tinting systems and which are both solvent-free and free of biocides and preservatives if the aqueous pigment paste comprises a certain amount of trivalent ions.

The use of trivalent ions, in particular compounds of trivalent metals, in particular aluminum compounds, makes it possible in particular to prevent colonization of aqueous compositions with alkaliphilic germs, in particular bacteria, yeasts and molds.

The aqueous compositions according to the invention, in particular pigment pastes, do not show any resistance formation by bacteria, yeasts or mold, in particular if they comprise an alkaline pH value. This is due in particular to the fact that trivalent ions often comprise weak germ-resistant properties, which applies in particular to aluminum ions. The use of compounds of trivalent metals, which release trivalent ions in aqueous solution, can in particular ensure that the pigment paste is emission-free, as the inorganic compound is ionic in nature and therefore cannot transition into the gas phase. This transition of active substances into the gas phase represents in particular the major disadvantage of solvent-based systems or of systems containing preservatives or biocides, since these substances are released to a large extent both during processing into the environment and are subsequently released by the coatings and accumulate in the room air, especially when used indoors.

In addition, the aqueous composition according to the invention, in particular pigment paste, is usually set to be alkaline, which further increases the germ-resistant effect.

It has also been shown in the applicant's experiments that the inorganic compound of the trivalent metal should comprise a certain solubility in aqueous systems, so that sufficient trivalent ions are present in the composition, which then produce a germ-resistant effect in accordance to the concentration or give compositions which contain the inorganic compound of the trivalent metal a significantly increased germ resistance. However, the concentration of the trivalent ions must not be too high, as otherwise the processing and application properties of the composition will be greatly impaired.

In the context of the present invention, it is usually envisaged that the inorganic compound of a trivalent metal, in particular the inorganic aluminum-containing compound, comprises a solubility of less than 4 g/l, in particular less than 3 g/l, preferably less than 2 g/l, more preferably less than 1.5 g/l, particularly preferred less than 1 g/l, at 20° C. in water.

Furthermore, it may be provided that the inorganic compound of a trivalent metal, in particular the inorganic aluminum-containing compound, comprises a solubility of more than 0.001 g/l, in particular more than 0.01 g/l, preferably more than 0.1 g/l, more preferably more than 0.2 g/l, particularly preferred more than 0.4 g/l, at 20° C. in water.

Furthermore, it may be envisaged in the context of the present invention that the inorganic compound of a trivalent metal, in particular the inorganic aluminum-containing compound, comprises a solubility in the range from 0.001 to 5 g/l, in particular 0.001 to 4 g/l, preferably 0.01 to 3 g/l, more preferably 0.1 to 2 g/l, particularly preferably 0.2 to 1.5 g/l, particularly preferred 0.4 to 1 g/l, at 20° C. in water.

It has been shown that such compounds of trivalent metals with low but not negligible solubility can be added to pigment pastes in large quantities without deteriorating the brilliance of the pigment pastes and the coating compositions obtained after incorporation of the pigment pastes into binder systems.

According to a preferred embodiment of the present invention, it is provided that the inorganic compound of a trivalent metal, in particular the inorganic aluminum-containing compound, further comprises a divalent metal.

It has been found that, in particular, inorganic compounds comprising divalent and trivalent metals comprise particularly good germ-resistant properties or that compositions comprising inorganic compounds comprising divalent and trivalent metals comprise particularly good germ-resistant properties. In the context of the present invention, it may be provided in particular that the divalent metal is selected from the group of magnesium, calcium, copper, manganese, iron, zinc and mixtures thereof. In this context, special results are obtained if the divalent metal is selected from magnesium, calcium, copper and mixtures thereof. Even more preferably, the divalent metal is calcium.

The inorganic compound of a trivalent metal, in particular the inorganic aluminum-containing compound, can be selected in particular from the group of magnesium aluminum phosphates, magnesium aluminum silicates, calcium aluminum phosphates, calcium aluminum silicates, calcium aluminate hydrates, calcium aluminate sulfate and mixtures thereof.

In the context of the present invention, best results are obtained if the inorganic compound of a trivalent metal, in particular the inorganic aluminum-containing compound, is selected from calcium aluminates.

It is well proven if the inorganic compound of a trivalent metal, in particular the inorganic aluminum-containing compound is selected from the group of calcium aluminate hydrates, calcium aluminate sulfate and mixtures thereof, preferably calcium aluminate sulfate.

Particularly good results are obtained in this context if the inorganic compound of a trivalent metal, in particular the inorganic aluminum-containing compound, is selected from the group of tricalcium aluminate hydrate [3 CaO*Al₂O₃*6 H₂O resp. Ca₃Al₂(OH)₁₂], tetracalcium aluminate hydrate [4 CaO*Al₂O₃*7 H₂O or Ca₄Al₂(OH)₁₄], calcium aluminate sulphate [ettringite, 3 CaO*Al₂O₃*3 CaSO₄*32 H₂O or Ca₆[Al(OH)₆]2(SO₄)₂*26 H₂O] and mixtures thereof. Special good results are obtained in this context if the inorganic compound of a trivalent metal, in particular the inorganic aluminum-containing compound, is selected from tetracalcium aluminate hydrate, calcium aluminate sulfate and mixtures thereof.

In the context of the present invention, it is particularly preferred if the inorganic compound of a trivalent metal, in particular the inorganic aluminum-containing compound, is calcium aluminum sulfate [ettringite, 3 CaO*Al₂O₃*3 CaSO₄*32 H₂O or Ca₆[Al(OH)₆]₂(SO₄)₂*26 H₂O]. The molecular formula is sometimes given as 24 molecules of water of crystallization, which differs from the notation of 26 molecules of water of crystallization shown above. However, the same compound is always meant.

Calcium aluminum sulfate is sold commercially in the form of aqueous suspensions. Calcium aluminate sulphate is composed of the mineral ettringite and contains a calcium oxide content of approx. 13.5 wt. %, an aluminum oxide content of approx. 8 wt. % and a water of crystallization content of approx. 45 wt. %. Calcium aluminum sulfate or ettringite or its aqueous dispersion is also occasionally used as a white pigment in architectural paints and in paper coatings. Calcium aluminum sulfate comprises a high covering power as well as a strong settling and rapid drying behavior, so that it cannot usually be used in high concentrations in aqueous dispersions, in particular in paints. However, it has been shown in the context of the present invention that calcium aluminum sulfate can be stabilized in an excellent manner in highly filled aqueous dispersions, so that storage-stable pigment pastes with a long open time can be obtained.

Even more surprising is the fact that with calcium aluminum sulfate biocide- and preservative-free pigment pastes, which are solvent-free and consequently emission-free, can be obtained which comprise a color brilliance and achieve color strengths, color locations and brilliances which are comparable to the currently used preservative- and biocide-containing standard pigment pastes.

The composition according to the invention, in particular pigment paste, can be used as a biocide- and preservative-free system, which furthermore comprises no solvents, i.e. is VOC-free, in all standard tinting systems currently in use. In particular, the compositions according to the invention, in particular pigment pastes, can be used for tinting paints without conversion on the commercially available and widely used machines.

Typically, it is envisaged in the context of the present invention that the inorganic compound of a trivalent metal, in particular the inorganic aluminum-containing compound, is present in particulate form.

In the context of the present invention, according to one embodiment, it may be envisaged that the inorganic compound of a trivalent metal, in particular the inorganic aluminum-containing compound, comprises a particle size distribution D10 in the range from 0.05 to 0.5 μm, in particular 0.1 to 0.4 μm, preferably 0.15 to 0.3 μm, more preferably 0.18 to 0.25 μm.

Similarly, it may be provided that the inorganic compound of a trivalent metal, in particular the inorganic aluminum-containing compound, comprises a particle size distribution D50 in the range from 1.0 to 4 μm, in particular 1.5 to 3.0 μm, preferably 1.8 to 2.7 μm, more preferably 2.0 to 2.5 μm.

Likewise, it may be envisaged that the inorganic compound of a trivalent metal, in particular the inorganic aluminum-containing compound, comprises a particle size distribution D90 in the range from 5.0 to 10 μm, in particular 5.5 to 8.0 μm, preferably 6.0 to 7.5 μm, more preferably 6.5 to 7.0 μm.

The terms D10, D50 and D90 each mean that 10% of all particles have a smaller particle size or 50% of all particles or 90% of all particles. The particle sizes or the particle size distribution can be determined in particular by laser scattering.

For this embodiment, it is particularly preferred if the inorganic compound of a trivalent metal, in particular the inorganic aluminum-containing compound, comprises a particle size distribution D10 of 0.2 μm, a particle size distribution D50 of 2 to 2.5 μm and a particle size distribution D90 of 6.8 μm. With the aforementioned particle size distributions, matt pigment pastes and paints with a high opacity can be obtained, in particular with the use of calcium aluminum sulfate (ettringite). However, the color location and color intensity are often strongly influenced compared to standard pigment pastes and the colors are not brilliant.

According to a particularly preferred embodiment of the present invention, the inorganic compound of a trivalent metal, in particular the inorganic aluminum-containing compound, comprises a particle size distribution D10 in the range from 0.05 to 0.45 μm, in particular 0.1 to 0.4 μm, preferably 0.15 to 0.3 μm, more preferably 0.18 to 0.25 μm.

Similarly, according to this embodiment, it may be provided that the inorganic compound of a trivalent metal, in particular the inorganic aluminum-containing compound, comprises a particle size distribution D50 in the range from 0.5 to 1.8 μm, in particular 0.6 to 1.5 μm, preferably 0.7 to 1.2 μm, more preferably 0.8 to 1.0 μm.

Furthermore, according to this embodiment, it may be provided that the inorganic compound of a trivalent metal, in particular the inorganic aluminum-containing compound, comprises a particle size distribution D90 in the range from 2.0 to 4 μm, in particular 2.2 to 3.7 μm, preferably 2.5 to 3.5 μm, more preferably 2.8 to 3.2 μm.

In the context of this preferred embodiment, it is particularly more preferred if the inorganic compound of a trivalent metal, in particular the inorganic compound containing aluminum, comprises a particle size distribution D10 of 0.2 μm, a particle size distribution D50 of 0.9 μm and a particle size distribution D90 of 3.0 μm. With these smaller particle sizes and narrower particle size distribution compared to the embodiment described above, it is possible to produce brilliant color pastes that can be added to standard pigment pastes in amounts of 15 wt. % or more without noticeably changing the brilliance of the color, the color location or the color intensity. It was not foreseeable that the inorganic compound of a trivalent metal, in particular the inorganic aluminum-containing compound, which are often white pigments, could be added to a pigment paste without appreciably changing the color properties and the application properties of the pigment paste and also of the binder system into which the pigment paste is incorporated.

According to a special embodiment of the present invention, the inorganic compound of a trivalent metal, in particular the inorganic aluminum-containing compound, comprises a bimodal particle size distribution. In particular, the inorganic compound of a trivalent metal, in particular the inorganic aluminum-containing compound, comprises a bimodal particle size distribution with the particle sizes and particle size distribution according to the different embodiments described above. In this way, the color space, color location, color intensity and brilliance of the composition, in particular of pigment pastes and the resulting coating compositions, can be set and determined in a targeted manner.

The present invention thus also enables the mixing of new colors in a simple manner by specifically setting the particle sizes of the inorganic compound of a trivalent metal, in particular the aluminum-containing inorganic compound. By controlling the particle size, the degree of matting or brilliance and the opacity of the composition, in particular of a pigment paste, can also be set.

As for the amount of the inorganic compound of a trivalent metal, in particular the inorganic aluminum-containing compound, in the composition, this can vary over a wide range, depending on which color effects and which germ-resistant properties are to be achieved.

In the context of the present invention, the composition usually comprises the inorganic compound of a trivalent metal, in particular the inorganic aluminum-containing compound, in amounts of 2 to 20 wt. %, in particular 5 to 15 wt. %, preferably 6 to 13 wt. %, more preferably 7 to 10 wt. %, based on the composition.

The composition according to the invention can thus obtain the inorganic compound of a trivalent metal, in particular the inorganic aluminum-containing compound, in very high amounts without changing or deteriorating the color brilliance of the pigment pastes compared to the biocide- and preservative-containing systems used up to now. The composition according to the invention thus allows a simple replacement of preservatives and biocides with the inorganic compound of a trivalent metal, in particular the inorganic aluminum-containing compound, in all common pigment pastes, preferably pigment pastes for tinting systems.

As previously configured, the composition usually comprises a basic pH value. In this context, it is specially well proven if the composition comprises a pH value of 9.5 or higher. Particularly good results are obtained in this context if the composition comprises a pH value in the range from 9.5 to 14, in particular 9.5 to 13, preferably 9.5 to 12, more preferably 9.5 to 11.5, more preferably 10.2 to 11.4.

In the context of the present invention, it is usually envisaged that the composition comprises a wetting or dispersing agent. The presence of wetting or dispersing agents is particularly advantageous to prevent sedimentation of the inorganic compound of a trivalent metal, in particular the inorganic aluminum-containing compound. Sedimentation of the inorganic compound of a trivalent metal, in particular the inorganic aluminum-containing compound, would lead to rapid unusability of the pigment pastes, which can be prevented by the use of wetting or dispersing agents. In addition, the dispersibility of pigments and fillers is also increased.

Furthermore, the use of wetting and dispersing agents is also advantageous due to the relatively high solubility of the inorganic compound of a trivalent metal, in particular the inorganic aluminum-containing compound, as small crystals grow at the expense of large crystals if residual solubility is present. This phenomenon is known as Ostwald ripening. In addition, agglomerates can grow together across the crystal boundaries. This results in larger particles, which can impair the color characteristics of pigment pastes due to the greater interaction with light and thus a higher proportion of white. Thanks to the targeted formulation with wetting and dispersing agents, the pastes remain stable without the formation of larger crystallites. The wetting agent can be added during the producing, in particular precipitation, of the particles of the inorganic compound of a trivalent metal, in particular the inorganic aluminum-containing compound. Advantageously, part of the total amount of wetting and dispersing agent is added during the producing, in particular precipitation, of the particles of the inorganic compound of a trivalent metal, in particular the inorganic aluminum-containing compound, while the remaining part of wetting and dispersing agent is added during the formulation of the composition according to the invention. Preferably, different wetting and dispersing agents are used in each case for producing the particles of the inorganic compound of a trivalent metal and the formulation of the composition according to the invention.

If the composition contains a dispersing agent, the wetting or dispersing agent is usually selected from the group of nonionic polymers, cationic polymers, anionic polymers and mixtures thereof, in particular nonionic copolymers, anionic copolymers, copolymers with pigment affinity groups, polyethers and mixtures thereof. A large number of surface-active substances can therefore be used as wetting and dispersing agents. Wetting and dispersing agents with pigment-affine groups are particularly preferred.

Particularly good results are obtained in the context of the present invention if the wetting or dispersing agent is selected from the group of polycarboxylates, in particular salts of polyacrylic acids, polyphosphates, in particular linear polyphosphates and/or cyclic methaphosphates, polyether phosphates, polycarboxylic acid polymers, acrylic block copolymers, ethoxylated fatty alcohols, non-ionic saturated long-chain alcohols, fatty alcohol sulphates, alkyl phosphonates, polysiloxane ethers, in particular methoxypolyethoxypropyl trisiloxanes, alkynyl ethoxylates, fluorosurfactants and mixtures thereof.

The molecular weight of the wetting or dispersing agent used can also vary over a wide range. Typically, the wetting or dispersing agent used comprises an average, in particular weight-average molecular weight of at least 1,000 g/mol, preferably at least 1,500 g/mol. In general, the polymeric stabilizer comprises an average, in particular weight-average molecular weight in the range from 1,000 to 1,000,000 g/mol, in particular 1,250 to 100,000 g/mol, preferably 1,500 to 75,000 g/mol, particularly preferred 2,000 to 50,000 g/mol.

Advantageously, the wetting or dispersing agent is configured on the basis of a functionalized, in particular acidic and/or basic functionalized, polymer, in particular with polar functional groups. For example, the wetting or dispersing agent can be selected from the group of functionalized polyamines, functionalized polyurethanes, functionalized poly(meth)acrylics, functionalized vinyl copolymers, functionalized polyether/polyester copolymers, functionalized polyethers, functionalized polyesters, functionalized fatty acid copolymers, functionalized block copolymers and/or functionalized polyalkoxylates as well as mixtures or combinations of at least two of these compounds.

Typically, the wetting or dispersing agent can be configured on the basis of a functionalized polymer, in particular an acidic and/or basic functionalized polymer, wherein the polymer contains at least one functional group, which may in particular be selected from the group of hydroxyl (—OH), thiol (—SH), amine, ammonium, carboxyl, carbonyl, ester, ether, sulfonyl, phosphonic acid, phosphoric acid and/or phosphoric acid ester functions, preferably hydroxyl (OH), thiol (—SH) and/or amine functions.

In the case of a basic functionalization, the base number of the polymer in particular can be at least 10 mg KOH/g, in particular at least 20 mg KOH/g, preferably at least 25 mg KOH/g, and in the case of an acidic functionalization, the acid number can be in particular at least 10 mg KOH/g, preferably at least 25 mg KOH/g, particularly preferred at least 50 mg KOH/g. In the case of polymers with acidic and basic functionalization, both aforementioned values apply.

Preferably, the wetting or dispersing agent may be selected from the dispersing and/or wetting agents mentioned below, as described in the following publications, the respective disclosure of which is hereby incorporated by reference:
polyurethanes according to EP 0 154 678 A and EP 0 318 999 A;
polyurethanes according to EP 0 270 126 A;
modified polyurethanes and polyamines according to EP 1 593 700 A;
salted polyamines according to EP 0 893 155 A;
phosphoric acid esters according to EP 0 417 490 A;
branched polymers containing imidazole groups according to EP 1 081 169 A;
ethoxylates, in particular alkoxylated epoxide/amine adducts, according to EP 1 650 246 A and epoxide adducts according to EP 1 486 524 A;
copolymers with fatty acid according to EP 1 640 389 A;
transesterified polyacrylates according to EP 0 879 860 A;
acid-functional polyesters according to WO 2005/097872 A;
block copolymers (gradient copolymers) according to EP 1 416 019 A.

Particularly good results are obtained in the context of the present invention if the composition contains the wetting or dispersing agent in amounts of 1 to 50 wt. %, in particular 3 to 45 wt. %, preferably 5 to 40 wt. %, more preferably 8 to 35 wt. %, based on the composition.

To stabilize both pigments and the inorganic compound of a trivalent metal, in particular the inorganic aluminum-containing compound, preferably larger amounts of wetting or dispersing agent are used in the composition.

According to a preferred embodiment of the present invention, the composition comprises
(a) an inorganic compound of a trivalent metal, in particular an inorganic aluminum-containing compound, in particular in amounts of 2 to 20 wt. %,
(b) a wetting or dispersing agent, in particular in amounts of 1 to 50 wt. %,
in each case related to the composition.

For this embodiment, all features, special features and advantages previously described in the context of the further embodiments apply according to.

In the context of the present invention, it is further preferably if the composition comprises a humectant.

In the context of the present invention, a humectant is to be understood as a compound capable of binding water and preventing the composition from drying out quickly. This is particularly important as many inorganic compounds of trivalent metals, in particular inorganic aluminum-containing compounds, dry out quickly. However, this is not acceptable for a pigment paste that is held in a tinting system machine for weeks.

If the composition contains a humectant, the humectant is usually selected from the group consisting of polyethylene glycols, tripropylene glycol, polypropylene glycol, polyacylene glycol, glycerol, glycerol ethoxylate, polyethers, polyurethanes and mixtures thereof

In the context of the present invention, good results are obtained if the composition contains the humectant in amounts of 0.1 to 30 wt. %, in particular 1 to 25 wt. %, preferably 2 to 20 wt. %, more preferably 5 to 15 wt. %, based on the composition.

In the context of the present invention, particularly good results are thus obtained if the composition contains
(a) an inorganic compound of a trivalent metal, in particular an inorganic aluminum-containing compound, in particular in amounts of 2 to 20 wt. %,
(b) a wetting or dispersing agent, in particular in amounts of 1 to 50 wt. %,
(c) a humectant, in particular in amounts of 0.1 to 30 wt. %,
in each case related to the composition.

For these embodiments, all features, special characteristics and advantages previously described in the context of the further embodiments apply accordingly to the present invention.

In the context of the present invention, it is usually envisaged that the composition comprises a pigment.

Typically, the pigment is selected from the group consisting of organic pigments, inorganic pigments and mixtures thereof.

Generally, the pigment used in the context of the present invention is selected from the group of organic and/or inorganic pigments, in particular pigment soot, metal oxides, in particular oxides of titanium, zinc, iron and/or cerium, and mixtures thereof.

Suitable organic pigments include, for example, nitroso, nitro, azo, xanthene, quinoline, anthraquinone, phthalocyanine, metal complex, isoindolinone, isoindoline, quinacridone, perinone, perylene, diketopyrrolopyrrole, thioindigo, dioxazine, triphenylmethane and quinophthalone compounds. Furthermore, the organic pigments can be selected from, for example: Carmine, carbon black, aniline black, azo yellow, quinacridone, phthalocyanine blue. Examples of these are: PY 74, PY 65, PY 110, PR 112, PR 122, PR 254, PR 168, PO 5, PG 7, PB 15:1, PB 15:2, PB 15:3, PB 15:4 and PBk 7.

Suitable inorganic pigments include, for example, metal oxides or other metal compounds that are sparingly soluble or at least essentially insoluble in water, in particular oxides of titanium, for example titanium dioxide (Cl 77891), zinc, iron, for example red and black iron oxide (Cl 77491 (red), 77499 (black)) or iron oxide hydrate (Cl 77492, yellow), zirconium, silicon, manganese, aluminum, cerium, chromium and mixed oxides of the aforementioned elements and mixtures thereof. Other suitable pigments are barium sulphate, zinc sulphide, manganese violet, ultramarine blue and Berlin blue pigments. The pigments can be surface-modified, wherein the surfaces can comprise hydrophilic, amphiphilic or hydrophobic compounds or groups as a result of the modification, for example. In particular, the inorganic pigments PR 101, PY 42, Pb 28, Pb 29, PW 6 and Pbk 33 can be used. The surface treatment can consist of providing the pigments with a thin hydrophilic and/or hydrophobic inorganic or organic layer according to methods known to the person skilled in the art.

In the context of the present invention, however, it is well proven if the pigment is selected from the group consisting of titanium dioxide, iron oxide yellow, iron oxide red, bismuth vanadate, carbon black, toluidine red, phthalocyanine, phthalocyanine blue, monoazo yellow, isoindolinone yellow, quinacridone, benzimidazolone, diketopyrrolopyrrole red and mixtures thereof.

Typically, the composition contains the pigment in amounts of 5 to 85 wt. %, in particular 6 to 80 wt. %, preferably 8 to 75 wt. %, more preferably 10 to 70 wt. %, based on the composition.

In the context of the present invention, particularly good results are thus obtained if the composition contains
(a) an inorganic compound of a trivalent metal, in particular an inorganic aluminum-containing compound, in particular in amounts of 2 to 20 wt. %,
(b) a wetting or dispersing agent, in particular in amounts of 1 to 50 wt. %,
(c) a humectant, in particular in amounts of 0.1 to 30 wt. %,
(d) a pigment, in particular in amounts of 5 to 85 wt. %,
in each case related to the composition.

Preferably, the aforementioned composition comprises a basic pH. For this embodiment of the present invention, all the aforementioned advantages, preferred features and special characteristics previously described in the context of other embodiments apply accordingly.

In particular, in the context of the present invention, it is usually envisaged that the composition comprises a pH adjusting agent. In a pH adjusting agent, the pH is in particular set to particularly preferred ranges both for the stability of the composition and to prevent infestation with germs.

The pH adjusting agent is usually selected from inorganic and organic acids and bases, in particular inorganic and organic bases, preferably inorganic bases.

If the composition contains a pH adjusting agent, it is well proven if the pH adjusting agent is selected from the group consisting of hydrochloric acid, sulfuric acid, nitric acid, citric acid, pyridinecarboxylic acid, acetic acid, sodium hydroxide, potassium hydroxide, lithium hydroxide, calcium hydroxide, ammonia, water glass, dimethylglucamine and mixtures thereof. Preferably, the pH adjusting agent is selected from the group consisting of sodium hydroxide, potassium hydroxide, lithium hydroxide, calcium hydroxide, ammonia, water glass, dimethylglucamine and mixtures thereof.

If the composition contains a pH adjusting agent, the composition usually contains the pH adjusting agent in amounts of 0.01 to 10 wt. %, in particular 0.1 to 8 wt. %, preferably 0.5 to 7 wt. %, more preferably 1 to 5 wt. %, based on the composition.

Advantageously, the composition usually comprises at least one additive. Typically, the additive is selected from the group of rheology additives, stabilizers, defoaming components, thickeners, pH stabilizers, rheology improvers and mixtures thereof.

Rheology additives or thickeners can be, for example, natural organic polymers and their derivatives with xanthan gum, gum arabic, karaya, tragacanth, locust bean gum, guar, quince mucilage, pectin, agar-agar, carrageenan, alginates, starch and starch derivatives, cellulose and derivatives thereof, such as methyl cellulose, carboxymethyl cellulose, hydroxyethyl cellulose, hydroxypropyl cellulose, hydroxypropyl methyl cellulose and methyl hydroxyethyl cellulose, as well as gelatine, preferably xanthan gum. Inorganic layered silicates such as bentonites, hectorites and magnesium-aluminum silicates can also be used, as well as thickeners based on polyacrylates (e.g. Carbopol types from Lubrizol, e.g. Carbopol ETD 2020 or Aqua SF-1), HEUR (Hydrophobically Modified Ethoxylated Urethane Polymers), polyurethane thickeners (e.g. special Aculyn grades from Rohm & Haas), colloidal silicic acid and urea and/or polyamide-based rheology modifiers, each of which can be used alone or in combination.

Suitable defoaming components are usually small amounts of hydrophobic components, such as vaseline oil (INCI: petrolatum), castor oil, mineral oils, vegetable oils or the silicone compounds known under the INCI names, such as Bisphenylhexamethicone, Dimethicone, Dimethicone Silylate, Dimethiconol, Diphenyl Dimethicone, Diphenylsiloxy Phenyl Trimethicone, Disiloxane, PEG/PPG-12/16 Dimethicone, PEG/PPG-12/18 Dimethicone, PEG/PPG-16/8 Dimethicone, PEG/PPG-8/26 Dimethicone, Phenetyl Disiloxane, Phenyl Dimethicone, Phenyl Trimethicone, Polysilicone-1, Polysilicone-2, Polysilicone-7, Polysilicone-8, Polysilicone-10, Silica Dimethicone Silylate, Silica Silylate, Simethicone, Trimethylsiloxysilicate, Trimethylsiloxysilicate/Dimethicone Crosspolymer, Triphenyl Trimethicone and Trisiloxane, Behenyl Methacrylate/Ethylamine Oxide, Methacrylate Copolymer, C12-14 Sec-Pareth-5, Hexamidine Diisothionate, Hexyldeceth-2, Laureth-5 Butyl Ether, Rhus Semialata Leaf Extract, as well as the combination of hydrophobic components with solids, for example silica, such as Sipernat® grades from Evonik Industries. Alcohols, such as ethanol, isopropanol, hexan-1-ol, propan-2-ol, can also have a defoaming effect, in particular in larger quantities.

If the composition comprises an additive, it is well proven if the composition contains the additive in amounts of 0.01 to 10 wt. %, in particular 0.1 to 8 wt. %, preferably 0.5 to 6 wt. %, more preferably 1 to 5 wt. %, based on the composition.

In the context of the present invention, particularly good results are thus obtained if the composition contains
(a) an inorganic compound of a trivalent metal, in particular an inorganic aluminum-containing compound, in particular in amounts of 2 to 20 wt. %,
(b) a wetting or dispersing agent, in particular in amounts of 1 to 50 wt. %,
(c) a humectant, in particular in amounts of 0.1 to 30 wt. %,
(d) a pigment, in particular in amounts of 5 to 85 wt. %,
(e) a pH adjusting agent, in particular in amounts of 0.1 to 10 wt. %,
(f) an additive, in particular in amounts of 0.01 to 10 wt. %,
in each case related to the composition.

For these embodiments, all features, advantages and characteristics previously described in the context of other embodiments apply accordingly.

As previously stated, the composition is an aqueous composition. In the context of the present invention, the composition typically comprises water in amounts of 1 to 80 wt. %, in particular 2 to 60 wt. %, preferably 3 to 50 wt. %, more preferably 5 to 40 wt. %, based on the composition.

In the context of the present invention, particularly good results are thus obtained if the composition contains
(a) an inorganic compound of a trivalent metal, in particular an inorganic aluminum-containing compound, in particular in amounts of 2 to 20 wt. %,
(b) a wetting or dispersing agent, in particular in amounts of 1 to 50 wt. %,
(c) a humectant, in particular in amounts of 0.1 to 30 wt. %,
(d) a pigment, in particular in amounts of 5 to 85 wt. %,
(e) a pH adjusting agent, in particular in amounts of 0.1 to 10 wt. %,
(f) an additive, in particular in amounts of 0.01 to 10 wt. %,
(g) water, in particular in amounts of 1 to 80 wt. %,
in each case related to the composition.

For this embodiment of the present invention, all the previously mentioned advantages, preferred features and special characteristics previously mentioned in the context of other embodiments apply accordingly.

In the context of the present invention, according to a preferred embodiment, it is further provided that the composition comprises a further inorganic or organic compound of a trivalent metal, in particular a further inorganic or organic aluminum-containing compound. This compound is usually significantly more soluble in water than the aforementioned inorganic compound of a trivalent metal. By the presence of a further inorganic or organic compound of a trivalent metal, for example, the solubility of the inorganic compound of a trivalent metal described above in detail, in particular the inorganic aluminum-containing compound, can be specifically set or reduced, since the solubility product of the inorganic compound of a trivalent metal is quickly exceeded by the addition of further compounds of trivalent metals, in particular in the case of additions containing the same ions.

In this way, a retarded solubility of the inorganic compound of a trivalent metal, in particular the inorganic aluminum-containing compound, can be achieved, since the compound only goes further into solution if the trivalent ions are removed from the equilibrium, for example by formation of poorly soluble compounds.

In the context of the present invention, particularly good results are obtained if the further inorganic or organic compound of a trivalent metal, in particular the further inorganic or organic aluminum-containing compound, is selected from the group of aluminum halides, in particular aluminum trichloride, aluminum hydroxide, aluminum hydroxide halides, in particular aluminum dihydroxide chloride, aluminum carboxylates and mixtures thereof.

If the composition contains a further inorganic or organic compound of a trivalent metal, in particular an inorganic or organic aluminum-containing compound, it is well proven if the composition contains the further inorganic or organic compound of a trivalent metal, in particular the further inorganic or organic aluminum-containing compound, in amounts of 0.1 to 5 wt. %, in particular 0.2 to 4 wt. %, preferably 0.3 to 3 wt. %, more preferably 0.5 to 2 wt. %, based on the composition.

In addition to the addition of a further inorganic or organic compound of a trivalent metal, in particular an inorganic or organic aluminum-containing compound, which, in particular when ions of the same type are added, reduces or retards the solubility of the inorganic compound of a trivalent metal with a solubility of less than 5 g/l at 20° C., there are further possibilities for reducing the solubility of the compound or producing a retarded solubility. For example, it is possible to encapsulate or coat the particles of the inorganic compound of a trivalent metal, in particular the inorganic aluminum-containing compound. The coating or the encapsulating material is either slightly porous or is degraded over time, so that a larger proportion of the inorganic compound of a trivalent metal, in particular the inorganic aluminum-containing compound, with a solubility of less than 5 g/l at 20° C. can go into solution with a time delay.

In addition, it is also possible to add surfactants, such as alkanecarboxylic acids, in particular oleic acid, to the particles of the inorganic compound of a trivalent metal, in particular the inorganic aluminum-containing compound, with a solubility of less than 5 g/l at 20° C., so that a double layer of the surfactant is configured on the surface of the particles, whereby the inorganic compound of a trivalent metal, in particular the inorganic aluminum-containing compound, is encapsulated, as it were, and the solubility is retarded.

In the context of the present invention, particularly good results are thus obtained if the composition contains
(a) an inorganic compound of a trivalent metal, in particular an inorganic aluminum-containing compound, in particular in amounts of 2 to 20 wt. %,
(b) a wetting or dispersing agent, in particular in amounts of 1 to 50 wt. %,
(c) a humectant, in particular in amounts of 0.1 to 30 wt. %,
(d) a pigment, in particular in amounts of 5 to 85 wt. %,
(e) a pH adjusting agent, in particular in amounts of 0.1 to 10 wt. %,
(f) an additive, in particular in amounts of 0.01 to 10 wt. %,
(g) water, in particular in amounts of 1 to 80 wt. %,
(h) a further inorganic compound of a trivalent metal, in particular in amounts of 0.1 wt. %, in each case related to the composition.

For the embodiment, all features, advantages and special characteristics previously described in the context of further embodiments apply accordingly.

In addition, it is possible that the composition contains fillers. If the composition contains fillers, the fillers are usually inorganic fillers. It is well proven if the fillers are selected from the group of barium sulfate, calcium carbonate, silicon dioxide, in particular amorphous silicon dioxide, silicates, talc, mica, kaolin, hollow microspheres and mixtures thereof.

Furthermore, good results are obtained if the composition contains the fillers in amounts of 1 to 30 wt. %, in particular 2 to 25 wt. %, preferably 3 to 20 wt. %, preferably 4 to 15 wt. %, particularly preferred 5 to 10 wt. %, based on the composition.

Furthermore, all embodiments of the aqueous composition preferably comprise a basic pH.

In the context of the present invention, it is usually envisaged that the composition is at least substantially free of preservatives, in particular free of preservatives.

Similarly, in the context of the present invention it is preferably envisaged that the composition is at least substantially free of biocides, in particular free of biocides.

The compositions according to the invention preferably contain no preservatives, no biocides and are also free of volatile organic compounds, i.e. VOC-free, so that they usually contain no substances requiring declaration and can be used easily and in a variety of ways from the point of view of environmental protection, health protection and occupational safety.

In addition, the compositions according to the invention are stable in storage, in particular over a period of at least 2 months, in particular at least 4 months, in particular at least 6 months, preferably at least 12 months. Similarly, it may be envisaged that the compositions according to the invention are storage-stable over a period of 2 to 36 months, in particular 4 to 20 months, in particular 6 to 18 months, preferably 12 to 15 months.

By “storage-stable” is meant that the physical and chemical properties of the composition do not change during storage or only change to an extent which does not impair the application properties of the composition.

Further subject-matter of the present invention—according to a second aspect of the present invention—is the use of a previously described aqueous composition as a pigment paste for tinting binder systems, in particular paints, preferably emulsion paints.

The binder system, in particular the tinting base or base composition, is preferably an aqueous binder system. Typically, the tinting base is an aqueous dispersion, a water-based paint, an emulsion paint, a lime paint, a silicate paint, a silicone resin paint, an emulsion silicate paint, a sol-silicate paint, a nanohybrid paint or a mixture thereof, preferably an emulsion paint. However, it is also possible that the tinting base is a solvent-based dispersion or a solvent-based paint. Preferably, however, an aqueous tinting base is used which is preferably solvent-free, comprising in particular a VOC content of less than 1 g/1.

As previously described, the tinting base usually contains a binding agent in an aqueous dispersion. In this case, it may be provided that the tinting base contains an organic binding agent in the form of an aqueous dispersion of a polymer. Preferably, the polymer is selected from acrylates, vinyl acetate and/or styrene, in particular based on pure acrylates and/or terpolymers of the compounds mentioned, preferably pure acrylates. Equally, however, an inorganic binding agent can also be used, such as for example water glass or silicic sol or also an organohybrid binding agent, in particular an aqueous organosilicate hybrid dispersion and/or starch and/or starch hybrid binding agent. Similarly, it is also possible to use acrylic resins, acrylic silicone resins, silicone resins, urethane resins, unsaturated polyester resins or alkyd resins and mixtures thereof.

Preferably, however, the tinting base comprises an organic binding agent. Particularly good results are obtained in this context if the tinting base comprises a polymer selected from vinyl acetate/ethylene copolymers, copolymers based on vinyl aromatics, in particular styrene and acrylates, or based on pure acrylates, in particular on the basis of pure acrylates. Pure acrylates comprise homo- and in particular copolymers of (meth)acrylates, i.e. acrylates and/or methacrylates, optionally also with (meth)acrylic acid, i.e. acrylic and/or methacrylic acid as a comonomer building block. The organic binding agent is preferably used in the form of an aqueous binder dispersion, as previously described.

For further details on the use according to the invention, reference can be made to the above explanations of the composition according to the invention, which apply accordingly to the use according to the invention.

A further subject-matter of the present invention—according to a third aspect of the present invention—is a kit-of-parts comprising a previously mentioned composition and a tinting base, in particular a coating composition, preferably an emulsion paint.

With the kit-of-parts according to the invention, almost any organic and inorganic binder systems can be obtained preservative-free and biocide-free in water-based, preferably purely water-based, systems.

The kit-of-parts according to the invention is suitable in particular for producing preservative-free and biocide-free tinting systems or tinted paint systems and for producing tinted aqueous glazes, water-based paints, paints, in particular emulsion paints, lime paints, silicate paints, silicone resin paints, emulsion silicate paints, sol-silicate paints and/or nanohydride paints. For further details of the tinting base, reference is made to the above configurations for use according to the invention

According to a preferred embodiment, the binding agent, in particular the emulsion paint, comprises a complexing agent and/or a pH stabilizer.

The presence of a complexing agent or a pH stabilizer in the tinting base, in particular the emulsion paint, is preferred, since the presence of trivalent and possibly also divalent ions in non-negligible amounts in the composition according to the invention, in particular pigment paste, often results in an undesirable thickening of the binder systems. This can be reliably prevented either by adding a complexing agent or often also a pH stabilizer.

In the context of the present invention, it is preferred if the tinting base or emulsion paint contains the complexing agent and/or the pH stabilizer in amounts of 0.1 to 10 wt. %, in particular 0.2 to 8 wt. %, preferably 0.5 to 5 wt. %, based on the tinting base.

If the tinting base, in particular the emulsion paint, contains a complexing agent, it is well proven if the complexing agent is selected from the group of phosphonic acids, phosphonates, polyphosphates, hydroxycarboxylic acids, dicarboxylic acids, amino acids, porphyrins and mixtures thereof, preferably phosphonic acids, phosphonates and mixtures thereof.

Particularly preferred is the complexing agent selected from the group of HEDP 1-hydroxyethane-(1,1-diphosphonic acid) (HEDP), pentasodium aminotrimethylenephosphonic acid (Na5ATMP)), tetrasodium hydroxyethane diphosphonic acid (Na4HEDP) and mixtures thereof.

As far as the pH stabilizer is concerned, this can be selected from a variety of systems. However, particularly good results are obtained in the context of the present invention if the pH stabilizer is selected from the group of pH buffer systems, in particular basic pH buffer systems.

For further details of the kit-of-parts according to the invention, reference can be made to the above explanations of the other aspects of the invention, which apply accordingly to the kit-of-parts according to the invention.

Again further subject-matter of the present invention—according to a fourth aspect of the present invention—is a composition, in particular a semi-finished product and/or a precursor, for producing a previously mentioned composition, in particular pigment paste, wherein the composition contains an inorganic compound of a trivalent metal, in particular an inorganic aluminum-containing compound, with a solubility of less than 5 g/l at 20° C. in water in amounts of 20 to 90 wt. %, based on the composition.

The composition according to this aspect of the present invention is preferably free of pigments. Further, the composition according to this aspect of the invention is preferably free of fillers. Further, the composition according to this aspect of the invention is preferably free of wetting and dispersing agents.

This further composition according to the invention, in particular the semi-finished product or precursor, enables simple mixing of pigment pastes at the manufacturers of pigment pastes, which is then optimized for the respective systems and machines. The further composition according to the invention only requires the addition of pigment as well as wetting agents and, if necessary, fillers in order to obtain the aqueous composition described above, in particular pigment paste.

Particularly good results are obtained in the context of the present invention if the further composition comprises the inorganic compound of a trivalent metal, in particular the inorganic aluminum-containing compound, in amounts of 20 to 80 wt. %, in particular 30 to 70 wt. %, preferably 40 to 65 wt. %, based on the composition.

Similarly, it may be envisaged in the context of the present invention that the further composition comprises water in amounts of from 5 to 75% by weight, in particular from 10 to 60% by weight, preferably from 15 to 50% by weight, more preferably from 20 to 35% by weight, based on the composition.

Preferably, it is preferably provided in the context of the present invention that the further composition comprises a humectant.

In this context, it may in particular be provided that the composition comprises the humectant in amounts of 0.5 to 15 wt. %, in particular 1 to 10 wt. %, preferably 1.5 to 8 wt. %, more preferably 1 to 5 wt. %, based on the composition.

Similarly, it may be envisaged within the scope of the present invention that the further composition comprises a pH adjusting agent. If the further composition comprises a pH adjusting agent, it is well proven if the composition comprises the pH adjusting agent in amounts of 0.01 to 10 wt. %, in particular 0.1 to 8 wt. %, preferably 0.5 to 7 wt. %, more preferably 1 to 6 wt. %, based on the composition.

Furthermore, it may be provided that the composition comprises an additive.

If the composition comprises an additive, good results are obtained if the composition comprises the additive in amounts of 0.05 to 10 wt. %, in particular 0.1 to 7 wt. %, preferably 0.1 to 5 wt. %, more preferably 0.2 to 3 wt. %, based on the composition.

For further details of this further composition according to the invention, reference may be made to the above explanations of the other aspects of the invention, which apply accordingly the further composition according to the invention.

Again further subject-matter of the present invention—according to a fifth aspect of the present invention—is a composition, in particular for spray applications, which contains an inorganic compound of a trivalent metal, in particular an inorganic aluminum-containing compound, with a solubility of less than 5 g/l at 20° C. in water in amounts of 5 to 50 wt. %, based on the composition.

Preferably, the composition according to this aspect of the present invention does not contain pigments.

This composition, which is optimized in particular for spray applications, is not intended to be mixed with pigments, but can be used in particular with conventional pigment pastes for sterilizing the vapor space in a tinting machine. The vapor space, i.e. the unfilled area of the pigment paste container in the tinting machine, is sprayed with the composition according to the invention in order to effectively combat germs, in particular mold.

According to this aspect of the present invention, it is preferably provided that the composition comprises the inorganic compound of a trivalent metal, in particular the inorganic aluminum-containing compound, in amounts of 5 to 45 wt. %, in particular 10 to 40 wt. %, based on the composition.

Similarly, it is preferably provided that the composition comprises water in amounts of from 50 to 95 wt. %, in particular from 55 to 95 wt. %, preferably from 60 to 90 wt. %, based on the composition.

Compared to the pigment paste according to the invention and the semi-finished product described above, this composition optimized for spray applications is significantly less viscous and comprises a significantly lower solid content.

However, the composition optimized for spray applications according to the invention offers a simple, preservative- and biocide-free way of effectively protecting the vapor space of pigment paste containers in tinting machines against germ infestation.

Within the scope of the present invention, it may further be provided that the composition comprises a humectant. The humectant is selected—as is readily apparent to a person skilled in the art—from the humectants previously mentioned in the context of the aqueous composition according to the invention.

If the composition comprises a humectant, good results are obtained if the composition contains the humectant in amounts of 0.5 to 15 wt. %, in particular 1 to 10 wt. %, preferably 1.5 to 8 wt. %, more preferably 1 to 5 wt. %, based on the composition.

Furthermore, it may be provided in the context of the present invention that the composition comprises an additive. The additive is usually selected from the same additives as previously mentioned in the context of the aqueous dispersion according to the invention.

Preferably, the composition comprises the additive in amounts of 0.05 to 10 wt. %, in particular 0.1 to 7 wt. %, preferably 0.1 to 5 wt. %, more preferably 0.2 to 3 wt. %, based on the composition.

For further details on this aspect, i.e. the composition optimized for spray applications, reference can be made to the above explanations of the other aspects of the invention, which apply according to the invention with respect to the composition according to the invention.

The subject-matter of the present invention is exemplified below in a non-limiting manner by means of the embodiment examples.

### Working Examples

Both microbiological and color measurements were carried out on pigment pastes containing calcium aluminate sulfate and these results were compared with identical pigment pastes containing biocides.

### Producing the Pigment Pastes

A total of three different test series of pigment pastes are carried out, each with different pigments. Test series 1 contains an organic blue pigment, test series 2 black pigments based on iron oxide and test series 3 a black pigment based on carbon black.

In each test series, a standard pigment paste containing biocides is produced as a comparative example, as well as examples according to the invention containing calcium aluminate sulphate in different amounts and with different particle sizes and particle size distributions. The comparative pastes and the pastes according to the invention differ in each case only in the replacement of biocide with calcium aluminate sulphate. The chemicals used are given in Table 1 below and the composition of the pigment pastes is given in Tables 2 to 4.

TABLE 1
Chemicals used

| Trade name/ | | |
|---|---|---|
| designation | Chemical description | Function |
| Calcium aluminate | Calcium aluminate sulphate | Function extender |
| sulphate | dispersion, 60 to 64 wt. % | |
| dispersion 1 | solids, | |
| (CAD 1) | D10 = 0.2 μm, D50 = | |
| | 0.9 μm, D90 = 3.0 μm | |
| Calcium aluminate | Calcium aluminate sulphate | Function extender |
| sulphate | dispersion, 61 to 63 wt. % | |
| dispersion 2 | solids, | |
| (CAD 2) | D10 = 0.8 μm; D50 = | |
| | 2-2.5 μm, D90 = 6.8 μm | |
| Calcium aluminate | Calcium aluminate sulphate, | Function extender |
| sulphate powder | powder | |
| (CAP) | D50 = 50-70 μm | |
| NaOH (10% ig) | Caustic soda | pH adjusting agent |
| KOH (10% ig) | Caustic potash solution | pH adjusting agent |
| TEA (85% ig) | Triethanolamine | pH adjusting agent |
| LiOH (10% ig) | Lithium hydroxide | pH adjusting agent |
| DMEA | Dimethylethanolamine | pH adjusting agent |
| Loxanol P 5814 | Polyethylene glycol | Humectant |
| Glycerin | Glycerol | Humectant |
| PEG 300 | Polyethylene glycol | Humectant |
| Loxanol P 5813 | Polyethylene glycol | Humectant |
| Loxanol P 5824 | Polyethylene glycol | Humectant |
| CliQSMART 129 | Urethane | Humectant |
| Edaplan 490 | Modified polymer with | Wetting agent |
| | pigment affinity groups | |
| Tego Dispers 760 W | Polymer with pigment | Wetting agent |
| | affinity groups | |
| Edaplan 910 | Modified polyglycol ester | Wetting agent |
| Disperbyk 199 | Copolymer with pigment | Wetting agent |
| | affinity groups | |
| Cliqsperse | Block copolymer | Wetting agent |
| Edaplan 395 | Copolymer with pigment | Wetting agent |
| | affinity groups | |
| Solsperse W100 | Polymer solution | Wetting agent |
| Metolat 394 | Olefinic copolymer | Wetting agent |
| Tego Dispers 747 W | Modified polymer with | Wetting agent |
| | pigment affinity groups | |
| Metolat 392 | Olefinic copolymer | Wetting agent |
| Byk-022 | Polyglycol/polysiloxane | Defoamer |
| | defoamer | |
| Agitan 731 | Siloxane | Defoamer |
| Drewplus L 1700 | Oil | Defoamer |
| Silfoam SC 369 | Organomodified silicone fluid | Defoamer |
| BYL-016 | Poylmer defoamer | Defoamer |
| AeroSil R 972 | Pyrogenic silicic acid | Rheology additive |
| Bentone EW | Smectite | Rheology additive |
| Laponite RD | Silicic acid, lithium | Rheology additive |
| | magnesium sodium salt | |
| Rheobyk 425 | Urea-modified polyurethane | Rheology additive |
| Cliqflow 681 | Non-ionic associative | Rheology additive |
| | thickener | |
| Tafigel PUR 82 | Polyurethane | Rheology additive |
| Silikolloid P87 | Silicic acid-kaolinite mixture | Rheology additive |
| puriss | | |
| Microtalc IT extra | Magnesium silicate hydrate | Rheology additive |
| Bayferrox 318 M | Iron oxide black | Pigment |
| Bayferrox 318 MB | Iron oxide black | Pigment |
| Comos-Blue | Phthalocyanine blue | Pigment |
| PRPL-A | | |
| Monarch 120 | Carbon black | Pigment |
| Blanc-fixe micro | Barium sulfate | Füllstoff |
| Polygloss 90 | Kaolin | Filler |
| Luzenac 20M0 | Magnesium hydrosilicate | Filler |
| Steopac | Magnesium hydrosilicate | Filler |
| China Clay Supreme | Kaolin | Filler |
| Syloid ED 3 | Amorphous silicon dioxide | Filler |
| Acematt OK 500 | Silicon dioxide | Filler |
| Minex 4 | Nepheline syenite | Filler |
| Silibeads Typ S | Micro glass beads 40-70 μm | Filler |
| (5211-7) | | |
| Acticide DB20 | 2,2-Dibromo-3- | Biocide |
| | nitrilopropionamide (20%) | |
| Acticide MV | 5-Chlor-2-methyl-4- | Biocide |
| | isothiazolin-3-on | |
| | and | |
| | 2-methyl-2H-isothiazol-3-one | |
| | Water | Dispersion medium |

TABLE 2
Test series 1 with organic blue pigment

| | | 1 | 1.1 | 1.2 | 1.3 |
|---|---|---|---|---|---|
| Water | [Weight parts] | 29.46 | 23.00 | 16.00 | 14.00 |
| pH adjusting agent | [Weight parts] | — | 1.04 | 1.20 | 3.00 |
| Humeactant | [Weight parts] | 5.00 | 5.00 | 5.00 | 5.00 |
| Wetting agent | [Weight parts] | 28.00 | 28.00 | 28.00 | 28.00 |
| CAD 1 | [Weight parts] | — | 5.00 | 15.00 | — |
| CAD2 | [Weight parts] | — | — | — | 15.00 |
| Defoamer | [Weight parts] | 0.20 | 0.20 | 0.20 | 0.20 |
| Rheology additive | [Weight parts] | 0.80 | 0.80 | 0.80 | 0.80 |
| Comos-Blue PRPL-A | [Weight parts] | 36.00 | 36.00 | 36.00 | 36.00 |
| Biocide | [Weight parts] | 0.54 | — | — | — |
| pH value | | 7.65 | 10.85 | 11.4 | 12.57 |

TABLE 3
Test series 2 with iron oxide-based black pigments

| | | 2 | 2.1 | 2.2 | 2.3 |
|---|---|---|---|---|---|
| Water | [Weight parts] | 26.26 | 15.60 | 9.60 | 9.60 |
| pH adjusting agent | [Weight parts] | — | 11.00 | 11.00 | 11.00 |
| Humeactant | [Weight parts] | 5.00 | 5.00 | 5.00 | 5.00 |
| Wetting agent | [Weight parts] | 7.00 | 7.00 | 7.00 | 7.00 |
| CAD 1 | [Weight parts] | — | 5.00 | 15.00 | — |
| CAD 2 | [Weight parts] | — | — | — | 15.00 |
| Defoamer | [Weight parts] | 0.35 | 0.35 | 0.35 | 0.35 |
| Rheology additive | [Weight parts] | 2.25 | 2.25 | 2.25 | 2.25 |
| Bayferrox 318 M ox. | [Weight parts] | 6.50 | 6.50 | 6.50 | 6.50 |
| black | | | | | |
| Bayferrox 318 MB ox. | [Weight parts] | 36.30 | 36.30 | 36.30 | 36.30 |
| black | | | | | |
| Filler | [Weight parts] | 15.80 | 11.00 | 9.00 | 9.00 |
| Biocide | [Weight parts] | 0.54 | — | — | — |
| pH value | | 7.16 | 12.20 | 12.06 | 12.03 |

TABLE 4
Test series 3 with black pigment based on carbon black

| | | 3 | 3.1 | 3.2 | 3.3 | 3.4 |
|---|---|---|---|---|---|---|
| Water | [Weight parts] | 20.56 | 17.10 | 12.80 | 17.75 | 6.30 |
| pH adjusting agent | [Weight parts] | — | 2.5 | 1.30 | 1.35 | 1.70 |
| Humeactant | [Weight parts] | 5.00 | 5.00 | 5.00 | 5.00 | 5.00 |
| Wetting agent | [Weight parts] | 29.50 | 29.50 | 29.50 | 29.50 | 29.50 |
| CAD 1 | [Weight parts] | — | 5.00 | 15.00 | — | — |
| CAD 2 | [Weight parts] | — | — | — | 15.00 | — |
| CAP | [Weight parts] | — | — | — | — | 5.00 |
| Defoamer | [Weight parts] | 0.20 | 0.20 | 0.20 | 0.20 | 0.20 |
| Rheology additive | [Weight parts] | 1.20 | 1.20 | 1.20 | 1.20 | 1.20 |
| Monarch 120 | [Weight parts] | 32.00 | 32.00 | 32.00 | 32.00 | 32.00 |
| Filler | [Weight parts] | 11.00 | 8.00 | 3.00 | 3.00 | 8.00 |
| Biocide | [Weight parts] | 0.54 | — | — | — | — |
| pH value | | 7.43 | 12.00 | 10.91 | 10.78 | 10.70 |

### Sterility Test

In order to test the germ resistance of the compositions according to the invention, compositions 1.1 to 1.3, 2.1 to 2.3 and 3.1 to 3.4 according to the invention are subjected to a sterility test based on DIN EN 17516 with the corresponding biocide-containing compositions 1, 2 and 3.

The results are listed in Table 5 below and show that the compositions according to the invention comprise comparable sterilities to the biocide-containing compositions, although they are free of preservatives and biocides.

TABLE 5
Results of the sterility tests performed

| | Sterility | MIT¹ | CIT² | BIT³ | Bronopol | ZnP⁴ |
|---|---|---|---|---|---|---|
| Sample | CASO/PS/SAB | in ppm | in ppm | in ppm | in ppm | in ppm |
| 1 | 0/0/0 | 0 | 57 | 0 | 0 | 0 |
| 1.1 | 0/0/0 | 0 | 0 | 0 | 0 | 0 |
| 1.2 | 0/0/0 | 0 | 0 | 0 | 0 | 0 |
| 1.3 | 0/0/0 | 0 | 0 | 0 | 0 | 0 |
| 3 | 0/0/0 | 0 | 53 | 0 | 0 | 0 |
| 3.1 | 0/0/0 | 0 | 0 | 0 | 0 | 0 |
| 3.2 | 0/0/0 | 0 | 0 | 0 | 0 | 0 |
| 3.3 | 0/0/0 | 0 | 0 | 0 | 0 | 0 |
| 3.4 | 0/0/0 | 0 | 0 | 0 | 0 | 0 |
| 2 | 0/0/0 | 0 | 59 | 0 | 0 | 0 |
| 2.1 | 0/0/0 | 0 | 0 | 0 | 0 | 0 |
| 2.2 | 0/0/0 | 0 | 0 | 0 | 0 | 0 |
| 2.3 | 0/0/0 | 0 | 0 | 0 | 0 | 0 |

¹Methylisothiazolinon
²Chlormethylisothiazolinon
³Benzisothiazolinon
⁴Zinkpyrithion

### Coloristic Comparison

The pigment pastes produced under 1.1 are each incorporated in amounts of 2 to 5 g for producing a lightened color and in an amount of 10 g for producing a solid color in 100 g of an acrylate-based dispersion paint and applied to a test plate, wherein in each case a comparative example and a paste according to the invention are applied in parallel to a test plate. After drying, the paint applications are compared.

### (a) Test Series 1

### a) Comparison of Pigment Pastes 1 (Comparison) and 1.1 (According to the Invention)

### b) Lightening

Mix 2 g of paste in 100 g of emulsion paint. Parallel application with 200 μm scraper and subsequent air drying.

The color strength decreases by approx. 2% due to the use of calcium aluminate sulfate. The color location remains approximately the same. There is no visual difference.

### B) Full Shade

Mix 10 g paste in 100 g emulsion paint. Parallel application with 200 μm scraper and subsequent air drying.

The color strength increases by approx. 1.4% due to the use of calcium aluminate sulfate and the color location also changes. It is clearly redder, yellower and dirtier. A visual difference is visible.

### a) Comparison of Pigment Pastes 1 (Comparison) and 1.2 (According to the Invention)

### b) Lightening

Mix 2 g of paste in 100 g of emulsion paint. Parallel application with 200 μm scraper and subsequent air drying.

The color strength decreases by approx. 12% due to the use of calcium aluminate sulfate. The color location changes. It is significantly lighter, yellower and dirtier. A visual difference is also visible.

### b) Full Shade

Mix 10 g of paste in 100 g of emulsion paint. Parallel application with 200 μm scraper and subsequent air drying.

The color strength is almost unchanged by the use of calcium aluminate sulfate, but the color location changes. This is significantly yellower and dirtier. A visual difference is visible.

### a) Comparison of Pigment Pastes 1 (Comparison) and 1.3 (According to the Invention)

### b) Lightening

Mix 5 g of paste in 100 g of emulsion paint. Parallel application with 200 μm scraper and subsequent air drying.

The color strength decreases by approx. 12% due to the use of calcium aluminate sulfate. The color location changes. It is clearly yellower and dirtier. A visual difference is visible.

### b) Full Shade

Mix 10 g of paste in 100 g of emulsion paint. Parallel application with 200 μm scraper and subsequent air drying.

The color strength is almost unchanged due to the use of calcium aluminate sulfate. However, the color location becomes yellower and dirtier. A visual difference is only faintly visible.

### 1.3.2.1 Comparison of Pigment Pastes 2 (Comparison) and 2.1 (According to the Invention)

### a) Lightening

Mix 5 g of paste in 100 g of emulsion paint. Parallel application with 200 μm scraper and subsequent air drying.

The color strength increases by approx. 5.6% due to the use of calcium aluminate sulfate. The color location changes. It is significantly lighter, yellower and dirtier. A visual difference is also visible.

### b) Full Shade

Mix 10 g paste in 100 g emulsion paint. Parallel application with 200 μm scraper and subsequent air drying.

The color strength is almost unchanged due to the use of calcium aluminate sulfate. The color location remains the same. A visual difference is only faintly visible.

### 1.3.2.2 Comparison of Pigment Pastes 2 (Comparison) and 2.2 (According to the Invention)

### a) Lightening

Mix 5 g of paste in 100 g of emulsion paint. Parallel application with 200 μm scraper and subsequent air drying.

Neither the color strength nor the color location are changed by the use of calcium aluminate sulfate. A visual difference is not recognizable.

### b) Solid Shade

Mixing of 10 g paste in 100 g emulsion paint. Parallel application with 200 μm scraper and subsequent air drying.

Neither the color strength nor the color location are changed by the use of calcium aluminate sulfate. A visual difference is clearly recognizable.

1.3.2.2 Comparison of Pigment Pastes 2 (Comparison) and 2.3 (According to the Invention)

a) Lightening

Mixing of 5 g paste in 100 g emulsion paint. Parallel application with 200 μm scraper and subsequent air drying.

The use of calcium aluminate sulphate increases the color strength by approx. 4%. The color location becomes slightly yellower and dirtier. A visual difference is only slightly recognizable.

### b) Full Shade

Mix 10 g paste in 100 g emulsion paint. Parallel application with 200 μm scraper and subsequent air drying.

The use of calcium aluminate sulphate reduces the color strength by approx. 1%. The color location is only minimally changed. A visual difference is clearly recognizable.

### 1.3.3.1 Comparison of Pigment Pastes 3 (Comparison) and 3.1 (According to the Invention)

### a) Lightening

Mix 2 g of paste in 100 g of emulsion paint. Parallel application with 200 μm scraper and subsequent air drying.

The use of calcium aluminate sulphate reduces the color strength by approx. 4%. The color location is only minimally changed. A visual difference is only slightly noticeable.

### b) Full Shade

Mix 10 g paste in 100 g emulsion paint. Parallel application with 200 μm scraper and subsequent air drying.

Neither the color strength nor the color location are changed by the use of calcium aluminate sulfate. A visual difference is clearly recognizable.

1.3.3.2 Comparison of Pigment Pastes 3 (Comparison) and 3.2 (According to the invention)

### a) Lightening

Mix 2 g of paste in 100 g of emulsion paint. Parallel application with 200 μm scraper and subsequent air drying.

The use of calcium aluminate sulphate reduces the color strength by approx. 4.5%. The color location is only minimally changed. A visual difference is only slightly noticeable.

b) Full shade

Mix 10 g of paste in 100 g of emulsion paint. Parallel application with 200 μm scraper and subsequent air drying.

Neither the color strength nor the color location are changed by the use of calcium aluminate sulfate. A visual difference is faintly recognizable.

### 1.3.3.3 Comparison of Pigment Pastes 3 (Comparison) and 3.3 (According to the Invention)

### a) Lightening

Mixing of 2 g paste in 100 g emulsion paint. Parallel application with 200 μm scraper and subsequent air drying.

The use of calcium aluminate sulphate reduces the color strength by approx. 2.4%. The color location is not changed. A visual difference can be recognized.

### b) Full Shade

Mix 10 g paste in 100 g emulsion paint. Parallel application with 200 μm scraper and subsequent air drying.

Neither the color strength nor the color location are changed by the use of calcium aluminate sulfate. A visual difference is faintly recognizable.

### 1.3.3.4 Comparison of Pigment Pastes 3 (Comparison) and 3.4 (According to the Invention)

### a) Lightening

Mixing of 2 g paste in 100 g emulsion paint. Parallel application with 200 μm scraper and subsequent air drying.

The use of calcium aluminate sulphate reduces the color strength by approx. 2%. The color location is not changed. A visual difference can be seen.

### b) Full Shade

Mix 10 g paste in 100 g emulsion paint. Parallel application with 200 μm scraper and subsequent air drying.

Neither the color strength nor the color location are changed by the use of calcium aluminate sulfate. A visual difference is faintly recognizable.

It has been shown that pigment pastes can be obtained with calcium aluminate sulphate, even in higher amounts, which are comparable to conventional biocide-containing pigment pastes in terms of color. In particular, brilliant colors can be obtained with the use of finely divided calcium aluminate sulfate.

1. An aqueous composition configured as a pigment paste for tinting systems, wherein the composition comprises an inorganic compound of a trivalent metal with a solubility of less than 5 g/l at 20° C. in water.

2. The composition according to claim 1, wherein the solubility of the inorganic compound ranges from 0.001 to 5 g/l at 20° C. in water.

3. The composition according to claim 1, wherein the inorganic compound further comprises a divalent metal.

4. The composition according to claim 1, wherein the inorganic compound is selected from calcium aluminates.

5. The composition according to claim 1, wherein the inorganic compound is selected from the group of calcium aluminate hydrates, calcium aluminate sulphate and mixtures thereof.

6. The composition according to claim 1, wherein the composition comprises a pH value of 9.5 or higher.

7. The aqueous composition according to claim 1, wherein the composition comprises a wetting or dispersing agent in amounts of 1 to 50 wt. % based on the composition.

8. The aqueous composition according to claim 1, wherein the composition comprises a humectant in an amounts of 0.1 to 30 wt. % based on the composition.

9. The aqueous composition according to claim 1, wherein the composition comprises a pigment selected from the group of organic pigments, inorganic pigments and mixtures thereof.

10. The aqueous composition according to claim 9, wherein the pigment is provided as 5 to 85 wt. % based on the composition.

11. The aqueous composition according to claim 1, wherein the composition is at least substantially free of preservatives and/or at least substantially free of biocides.

12. A method of using the composition of claim 1, the method comprising using the composition to tint a binder system for a paint.

13. A kit for a paint, the kit comprising the composition of claim 1 and a tinting base.

14. The kit according to claim 13, wherein the tinting base comprises a complexing agent and/or a pH stabilizer in amounts of 0.1 to 10 wt. % based on the paint.

15. A second composition configured as a semi-finished product and/or precursor, the second composition being configured for producing the composition according to claim 1, wherein the second composition comprises an inorganic compound of a trivalent metal with a solubility of less than 5 g/l at 20° C. in water, in amounts of 20 to 90 wt. %, based on the composition.

16. The second composition according to claim 15, wherein the second composition comprises the inorganic compound in amounts of 20 to 80 wt. % based on the composition.

17. The second composition according to claim 15, wherein the second composition comprises water in amounts of 5 to 75 wt. % based on the composition.

18. The second composition according to claim 15, wherein the second composition comprises a humectant in an amount of 0.5 to 15 wt. % based on the composition.

19. A composition configured for spray applications, wherein the composition contains an inorganic compound of a trivalent metal with a solubility of less than 5 g/l at 20° C. in water in amounts of 5 to 50 wt. %, based on the composition.

20. The composition according to claim 19, wherein the composition comprises the inorganic compound in amounts of 5 to 45 wt. % based on the composition.

21. The composition according to claim 19 wherein the composition comprises water in amounts of 50 to 95 wt. % based on the composition.
